(19) United States
(12) Patent Application Publication
(10) Pub. No.: US 2025/0076581 A1
(43) Pub. Date: Mar. 6, 2025

(54) FIBER OPTIC CABLE CUTTING TOOL STRUCTURALLY CONFIGURED TO PROVIDE CONSISTENT CUTTING OF A CABLE JACKET WITHOUT DAMAGING FIBERS IN THE CABLE JACKET

(71) Applicant: PPC BROADBAND, INC., East Syracuse, NY (US)

(72) Inventor: Rijoy PARAMBATH, Kochi (IN)

(73) Assignee: PPC BROADBAND, INC., East Syracuse, NY (US)

(21) Appl. No.: 18/823,640

(22) Filed: Sep. 3, 2024

(30) Foreign Application Priority Data
Sep. 3, 2023 (IN) 202321059008

(51) Int. Cl. G02B 6/25

(52) U.S. Cl. CPC G02B 6/25

(57) ABSTRACT

A fiber optic cable cutting tool may include a body portion structurally configured to receive a fiber optic cable, a cutting portion holding portion structurally configured to be supported by the body portion, and a sliding portion structurally configured to be slidingly received by a portion of the body portion. The cutting portion holding portion may be structurally configured to receive a biasing portion and to fixedly hold the cutting portion, and the body portion may be structurally configured to set a length of a jacket of a fiber optic cable to be cut by the cutting portion. The sliding portion may be structurally configured to slide relative to the body portion so as overcome a force of the biasing portion and urge the cutting portion toward a cable held by the body portion such that the cutting portion is configured to consistently cut a jacket of the fiber optic cable held by body portion along the set length as the body portion is slid relative to the fiber optic cable without cutting a fiber in the fiber optic cable.

### CROSS-REFERENCE TO RELATED APPLICATION

This application claims the benefit of Indian Provisional Patent Application No. 202321059008, filed in India on Sep. 3, 2023, the disclosure of which is hereby incorporated by reference herein in its entirety.

### TECHNICAL FIELD

The present disclosure is directed to a cable tool and, more particularly, to a fiber optic cable cutting assembly.

### BACKGROUND

Fiber optic signal transmission can provide enhanced speed over many existing transmission technologies. With increased use of fiber optic cables for residential, commercial, and industrial sites, greater volumes of fiber optic cable installations are necessary to establish a reliable signal distribution network. The result of research and development of fiber optic technologies has prompted upgrades to existing installations, which involves reworking and/or replacing fiber optic cable.

Installation and alterations of portions of a fiber optic network can increase the opportunity and risk for incorrect cable handling and/or installation. In addition, many fiber optic cable handling operations are conducted by hand, which increases installation times and delays in fiber optic network operation. For these reasons, it is a continued goal for cable interconnections to be configured to provide more robust resistance to mechanical and environmental stresses along with reduced susceptibility to installation delays and errors.

It may be desirable to provide a fiber optic cable cutting tool configured to cut a fiber optic cable at a set length without cutting a fiber in the fiber optic cable. It may be desirable to provide a cable cutting tool configured to cut a jacket of a cable at a set length without cutting elements contained by the jacket of the cable.

### SUMMARY

In accordance with various aspects of the disclosure, a fiber optic cable cutting tool structurally may include a body portion configured to receive a fiber optic cable, a cutting portion holding portion structurally configured to be supported by the body portion, and a sliding portion structurally configured to be slidingly received by a portion of the body portion. The cutting portion holding portion may be structurally configured to receive an urging portion and to fixedly hold the cutting portion, the body portion may comprise a bottom portion and a top portion structurally configured to receive a cable holding portion therebetween, and the cable holding portion may be structurally configured to pivot relative to the top portion and the bottom portion between an open position and a closed position. The bottom portion may include a cable guide portion structurally configured to receive a fiber optic cable, the cable guide portion may include an opening portion configured to receive the cutting portion, and the cable holding portion and the cable guide portion may be structurally configured to hold the fiber optic cable in the closed portion. The cable guide portion may include a stop portion that is structurally configured to set a length of a jacket of a fiber optic cable to be cut by the cutting portion and the sliding portion may be structurally configured to slide relative to the bottom portion so as overcome a force of the biasing portion and urge the cutting portion through the opening portion into the cable guide portion such that the cutting portion is configured to consistently cut a jacket of a fiber optic cable held by the cable holding portion and the cable guide portion along the set length as the bottom portion is slid relative to the fiber optic cable without cutting a fiber in the fiber optic cable

In accordance with various aspects of the disclosure, a fiber optic cable cutting tool may include a body portion configured to receive a fiber optic cable, a cutting portion holding portion structurally configured to be supported by the body portion, and a sliding portion structurally configured to be slidingly received by a portion of the body portion. The cutting portion holding portion may be structurally configured to receive a biasing portion and to fixedly hold the cutting portion, the body portion may include a cable guide portion structurally configured to receive a fiber optic cable, and the cable holding portion and the cable guide portion may be structurally configured to hold the fiber optic cable. The cable guide portion may be structurally configured to set a length of a jacket of a fiber optic cable to be cut by the cutting portion; and the sliding portion may be structurally configured to slide relative to the body portion so as overcome a force of the biasing portion and urge the cutting portion into the cable guide portion such that the cutting portion is configured to consistently cut a jacket of a fiber optic cable held by the cable holding portion and the cable guide portion along the set length as the body portion is slid relative to the fiber optic cable without cutting a fiber in the fiber optic cable.

In accordance with various aspects of the disclosure, a cable cutting tool may include a body portion structurally configured to receive a cable, a cutting portion holding portion structurally configured to be supported by the body portion, and a sliding portion structurally configured to be slidingly received by a portion of the body portion. The cutting portion holding portion may be structurally configured to receive a biasing portion and to fixedly hold the cutting portion, and the body portion may be structurally configured to set a length of a jacket of a cable to be cut by the cutting portion. The sliding portion may be structurally configured to slide relative to the body portion so as overcome a force of the biasing portion and urge the cutting portion toward a cable held by the body portion such that the cutting portion is configured to consistently cut a jacket of the cable held by the body portion along the set length as the body portion is slid relative to the cable without cutting an element contained by the jacket of the fiber optic cable.

### BRIEF DESCRIPTION OF THE DRAWINGS

Further advantages and features of the present disclosure will become apparent from the following description and the accompanying drawings, to which reference is made.

FIG. 1 is a line representation of portions of a cable assembly in which assorted embodiments of the disclosure can be practiced.

FIG. 2 is a line representation of portions of an exemplary fiber optic cable that can be employed in the environment of FIG. 1 in various embodiments of the disclosure.

FIGS. 3A-3D respectively convey assorted views of portions of an exemplary cable cutting tool in accordance with embodiments of the disclosure that can be employed with the cable of FIG. 2.

FIGS. 4A-4C respectively show perspective views of portions of an exemplary cable cutting tool employed in accordance with various embodiments of the disclosure.

FIGS. 5A and 5B respectively provide perspective views of portions of an exemplary fiber optic cable that can be utilized in the tools of FIGS. 3A-4C.

### DETAILED DESCRIPTION

Embodiments of the disclosure provide a fiber optic cable cutting tool that is structurally configured to cut a jacket of the cable without cutting other elements of the cable so as to provide consistent jacket removal.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

Fiber optic cables, particularly cables arranged with a substantially flat outer shape, can be time consuming to install and prone to damage during an installation. Existing tools can conduct some cable installation operations, but can be awkward and prone to damaging portions of the fiber optic cable. Hence, many technicians conduct fiber optic cable installation operations by hand, which also can be time consuming and involve risk of cable damage. Accordingly, embodiments are directed to a fiber optic cable cutting tool that increases fiber optic cable installation speed while mitigating installation risks for cable damage.

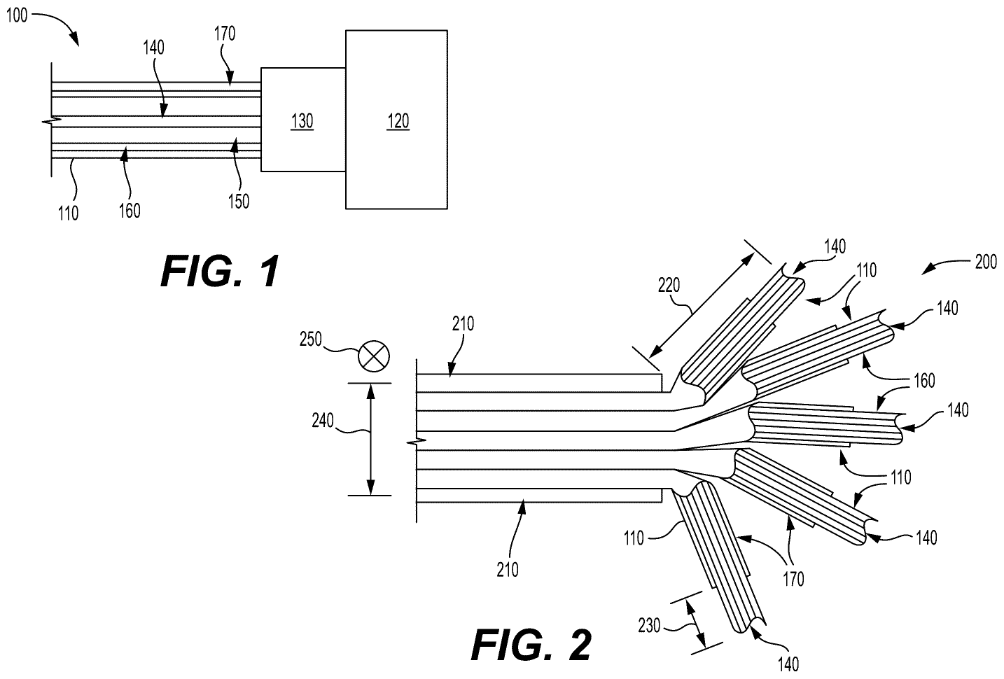

Turning to the drawings, FIG. 1 displays a line representation of an exemplary cable assembly 100 that can be a part of a signal, or data, distribution network arranged in accordance with various embodiments. Any number of fiber optic cables 110 can engage, connect, and digitally interact with an interconnect 120, such as a device, interface, cassette, or site terminal.

Although not required or limiting, the cable 110 can fit to the interconnect 120 via a connector 130 that physically supports the cable-to-interconnect connection while maintaining a reliable data/signal interface between the interconnect 120 and a signal transmission conductor 140 of the cable 110. While the signal transmission conductor 140 can be any size and type with any transmission capabilities, various embodiments configure the conductor 140 to be a continuous fiber optic conduit. Such a fiber optic conduit 140 is surrounded by an insulating material 150. One or more shielding layers 160 can be positioned to contact the insulating material 150 and protect the transmission of data/signals from physical, magnetic, and/or electrical interference. An outer jacket 170 wraps around the collective shielding layer(s) 160 to provide physical retention and protection.

The number of constituent layers and materials can contribute to the overall diameter and operational performance characteristics of the cable 110. It is contemplated that more than one connector 130 and cable 110 concurrently contact and communicate with the interconnect, but such arrangement is not required or limiting. While the outer jacket 170 can contain a single signal transmission conductor 140, in some embodiments, other configurations of the cable 110 provide multiple conductors. As an example, the fiber optic cable 200 illustrated in FIG. 2 represents how a single, unitary outer jacket 210 can contain several separate cables 110, in accordance with various embodiments.

The cable 200 can contain any number and condition of signal transmission conductors 140. In the example shown in FIG. 2, the cable 200 has a unitary cable jacket 210 that contains multiple jacketed cables 110 that each, respectively, contain conductors 140, insulators 150, shielding layers 160, and outer jackets 170. In some embodiments, the cable 200 has twelve separate signal conductors 140 that may, or may not, be individually contained within cable jackets 170.

While the packaging of separate conductors 140 within a single cable jacket 210 may provide some convenience and ease during installation, connection of a signal transmission conductor 140 to a connector 130, interface 120, or other installation connection can involve stripping portions of both the cable outer jacket 210 and the individual cable jackets 170 to allow constituent portions of the respective cables 110 to be physically engaged with an external component, such as a connector 130 or interconnect 120, to establish a stable digital signal pathway.

As shown in FIG. 2, the outer jacket 210 of the cable 200 is removed a predetermined length 220 without removing portion of the underlying cables 110. Such cutting of the outer jacket 210 reveals, and allows access to, the respective cables 110. To connect the respective cables 110 to a connector 130 and/or interconnect 120, a selected distance 230 of the outer cable jacket 110 is removed.

The removal of the outer jackets 210/170 from the respective cables 200/110 can be tedious and prone to damage of the underlying layers, shielding materials 160, and signal transmission conductors 140. For instance, removal of the respective cable outer jackets 210/170 can involve different tools configured to remove cables with different diameters and/or shapes. In the instance when one or more of the cables 200/110 are not substantially round, such as when the cross-sectional distance 240 along the Z axis is smaller than the cross-sectional distance 250 along the X axis, which can be characterized as a flat cable.

As a result of the challenges associated with stripping and engaging cables 200 comprising multiple other cables 110 and/or having a non-circular cross-sectional shape, such as a flat cable, many technicians strip the cables 200/110 by hand, which can cause installation delays and opportunities to inadvertently damage signal transmission conductors 140. Thus, various embodiments are directed to a single tool that can accurately and efficiently strip a cable 200, particularly a flat-shaped cable 200, without damaging the multiple constituent cables 110 contained therein.

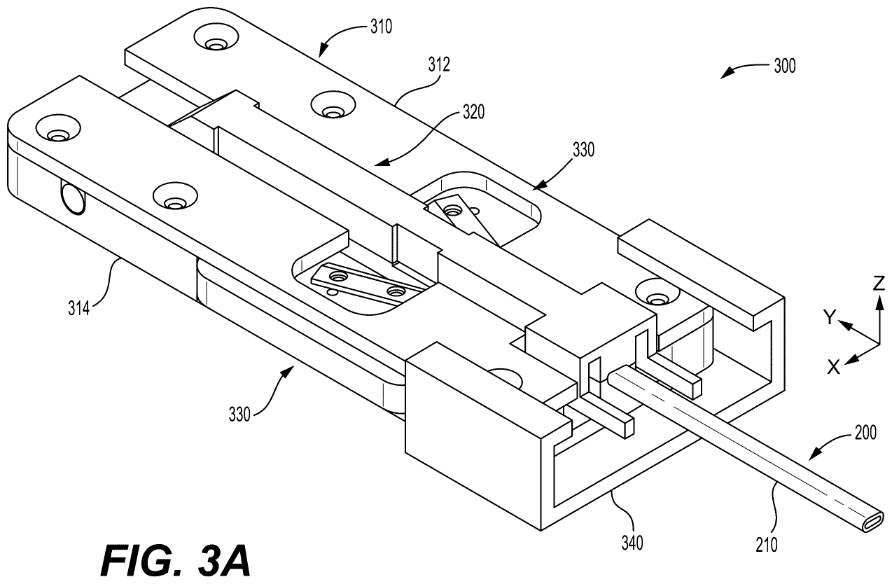

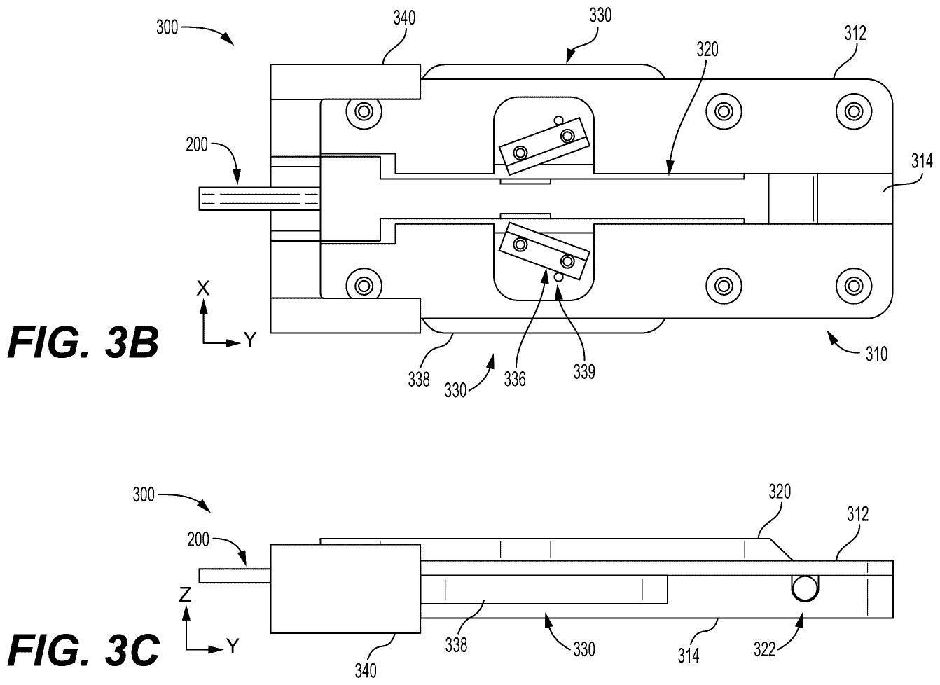

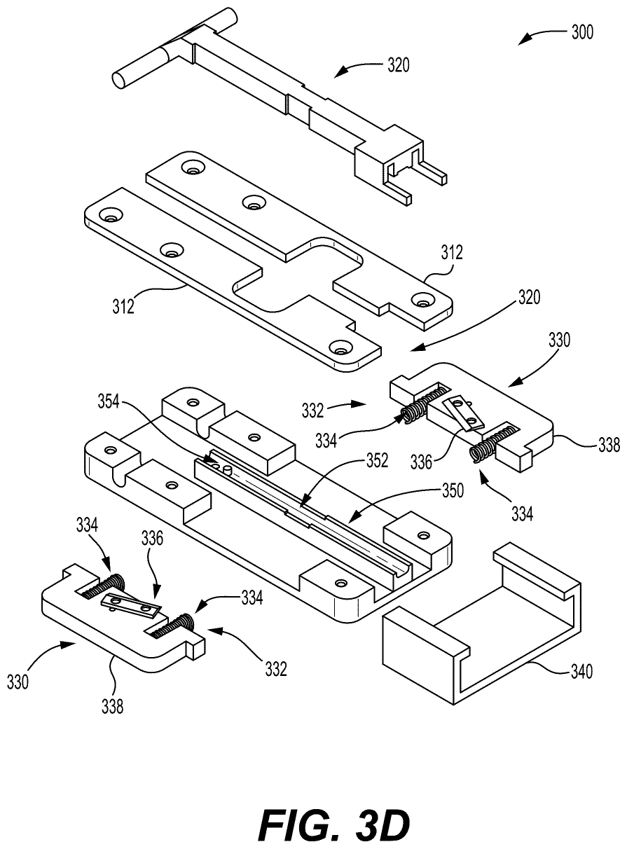

FIGS. 3A-3D respectively illustrate assorted views of an exemplary fiber optic cable cutting tool 300 that can be employed, in accordance with various embodiments, to efficiently and safely strip a predetermined length 220. The tool 300 has a body portion 310, for example, a rigid body, that comprises a top portion 312 that mates to a bottom portion 314. The top portion 312 has a slot that receives a cable holding portion or cable holder 320 and allows the holder 320 to rotate about the X axis, as shown with the pivot 322 positioned between the two body portions 312/314.

The body portions 312/314 also contain a cutting portion holding portion 330, for example a pair of cutting portion holding portions 330 positioned on opposite lateral sides, along the X axis, of the cable holder 320. The respective cutting portion holding portions 330 provide blades that are each supported by suspensions that allow for cutting of the outer cable jacket 210 without damaging underlying cables 110 and materials, such as shielding or reinforcing layers of the cable 200. The suspensions of the respective cutting portion holding portions 330 provide consistent force outward from the cable 200 and cable holder 320 until a sliding portion or sliding member 340 is moved to overcome the force of the respective suspensions so that the blades contact and split the cable's outer jacket 210.

The top view of the cable cutting tool 300 shown in FIG. 3B conveys how the cable holder 320 is positioned respective to the top body portion 312 and the respective cutting portion holding portions 330. The lateral extent of the sliding member 340, as measured along the X axis, is greater than the lateral extent of the cutting portion holding portions 330 when the suspensions of the respective cutting portion holding portions cutting portion holding portions 330 are not compressed and allowed to push cutting portions 336, for example, cutting blades, away from the cable holder 320.

FIG. 3C illustrates a side view of the cable cutting tool 300 with the sliding member 340 positioned to allow the fiber optic cable 200 to be inserted into the tool 300, which matches the tool configuration shown in FIGS. 3A and 3B. The side view of FIG. 3C conveys how the cable holder pivot 322 is created via a notch in the bottom body portion 314 that is continuously covered by the top body portion 312. It is noted that the body portions 312/314 can be temporarily, or permanently, affixed to one another via any number, type, and position of features, such as glue, adhesive, screws, magnets, buttons, or rivets, so that the collective body 210 is rigid and stable during cable insertion and removal.

The exploded view of FIG. 3D conveys an exemplary configuration of the respective components that can be assembled into the fiber optic cable cutting tool 300 shown in FIGS. 3A-3C. While various components of the tool 300 are shown in FIG. 3D as unitary pieces, such construction is not required and any component can comprise a lamination or assembly of multiple separate pieces. For instance, the bottom body portion 314 can be constructed of several separately manufactured pieces that are subsequently joined, or assembled, into the form shown in FIGS. 3A-3D.

The separated components shown in FIG. 3D illustrate how the cutting portion holding portions 330 has a suspension portion 332 comprising a biasing portion 334, for example, a pair of biasing members 334, such as springs, positioned on opposite sides of the cutting portion 336 to apply, in embodiments, constant and consistent force on a body portion 338 from a cable guide portion 350 of the bottom body portion 314. The cable guide portion 350 is arranged, in accordance with some embodiments, with a cable receiving portion 352, for example, a continuous channel, shaped to receive a cable, such as cable 200 or cable 110, which may in some aspects be a fiber optic cable or a multifiber cable. One or more cable stop portions 354 prevent a cable 200/110 from being inserted too far into the channel 352, holder 320, or tool 300. It is contemplated that a cable stop portion 354 is moveable to allow a predetermined length of cable 200/110 to engage the blades 336 of the respective slicing assemblies 330. As such, the cable stop portion 354 can provide a consistent length 220 of cable cutting to reveal constituent layers and cables 110.

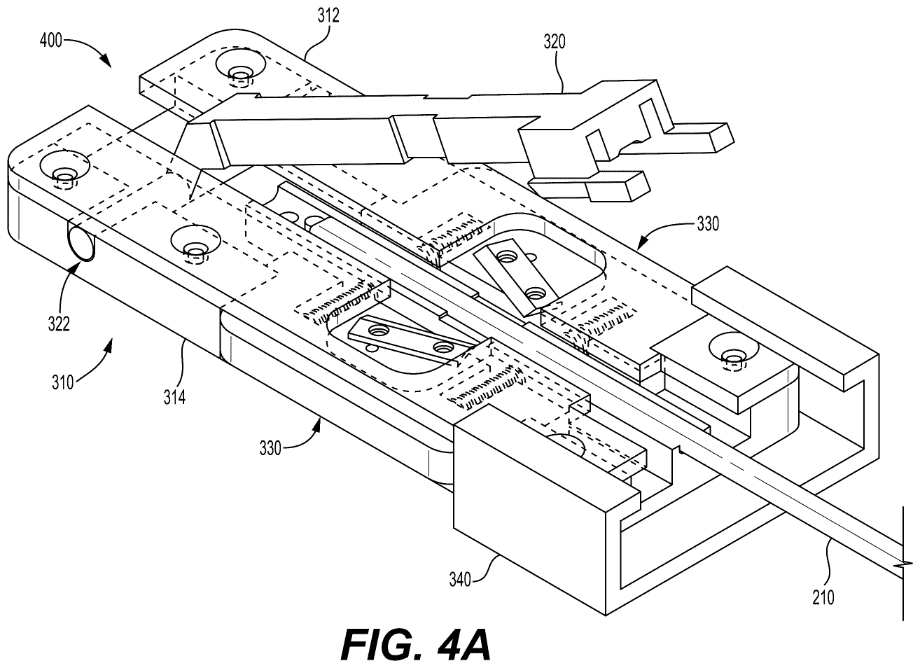

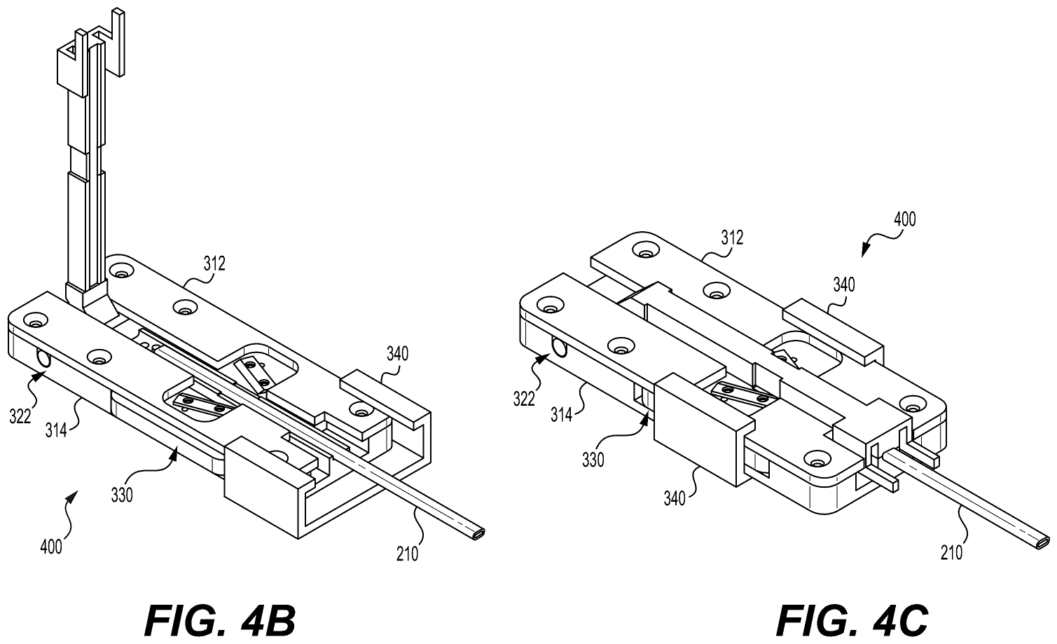

FIGS. 4A-4C respectively display perspective views of an exemplary fiber optic cable cutting tool 400 that is arranged and operated in accordance with various embodiments. Initially, it is noted that the top body portion 312 is shown in FIG. 4A as a shadow to display the configuration of the slicing assemblies 330 relative to the tool body 310. The cable holder 320 in FIGS. 4A and 4B is shown in open positions that reveal the channel 352 and stop portion 354 of the cable guide portion 350. The position of the cable holder 320 can be characterized as open when not in contact with a cable or the cable guide portion 350, as illustrated by different open positions in FIGS. 4A and 4B compared to the closed portion shown in FIG. 4C.

The partially translucent top body portion 312 in FIG. 4A conveys how each slicing body 338 is retained from moving too far away from the cable guide portion 350, due to the force of the biasing members 334, by engaging portions of the bottom body portion 314. The opaque display of the top body portion 312 in FIGS. 4B and 4C respectively conveys how the top body portion 312 is arranged to expose the blades 336. Such configuration allows the blades 336 to be easily inspected and replaced, if necessary, without disassembling the top body portion 312 from the bottom body portion 314.

In operation, the holding portion 320 is moved to an open position, as illustrated by FIGS. 4A and 4B. Then, as illustrated in FIG. 4C, the holding portion 320 is moved to the closed position, and the sliding member 340 is moved into contact with the respective slicing assemblies 330 to compress each of the force members 334 and collectively move each blade 336 through an opening portion 351 in the guide portion 350 towards the cable 200/110 contained within the guide portion 350 and cable holder 320. It is noted that the respective blades 336 are not in contact with the cable 200/110 until the sliding member 340 contacts and moves each of the slicing mechanisms 330. With the blades 336 of the slicing mechanisms 330 contacting the cable 200/110, as illustrated in FIG. 4C, a user simply pulls the cable 200/110 from the tool 400, which forces the blades 336 to score, cut, and separate the outer jacket 210/170 of the cable 200/110 to allow easy access to the constituent conductors 140.

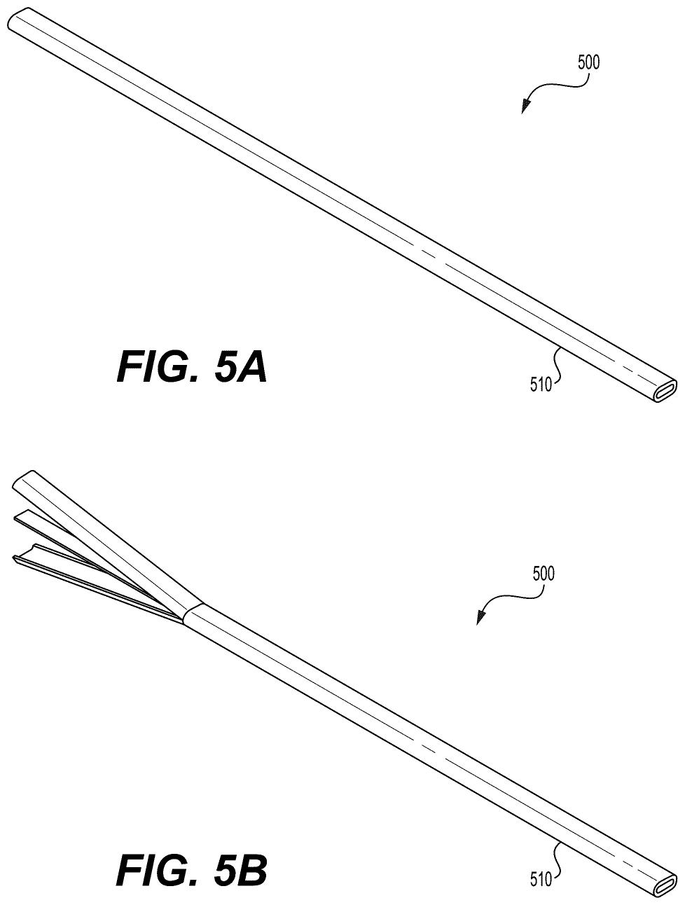

FIGS. 5A and 5B respectively illustrate a cable 500 before (FIG. 5A) and after (FIG. 5B) engagement with the cable cutting tool 300/400 shown in FIGS. 3A-4C. It is noted that the cable 500 has an oblong cross-sectional shape that can be characterized as a flat cable. It is contemplated that the cable 500 houses multiple signal conductors, such as fiber optic conductors.

Once the outer jacket 510 of the cable 500 is secured within a cable cutting tool 300/400 with the cable holder 320, the sliding member is moved to depress the slicing assemblies 330 toward the cable 500 to a point where the cable outer jacket 510 is punctured. Physical removal of the cable 500 while the cable holder 320 and sliding member 340 remain in place causes the blades 336 to continuously cut the outer jacket 510, as shown in FIG. 5B. Such a cut to the cable's outer jacket 510 allows visual and physical access to the constituent materials and conductors of contained within the outer jacket 510.

Through the use of the cable cutting tool 300/400, a cable can be safely and efficiently split to reveal underlying materials, cables, and conductors without damaging those materials, cables, and conductors. The ability to set a cable stop in the cutting tool 300/400 allows for consistent outer jacket 510 split lengths with maximum efficiency. With the cable cutting tool 300/400 capable of cutting the outer jacket 510 of a diverse array of cable shapes, such as flat, round, or oval, a technician can quickly strip designated portions of a cable 500 without concern for providing unwanted cut lengths or damaging underlying materials, cables, or conductors.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic cable cutting tool structurally configured to cut a fiber optic cable at a set length without cutting a fiber in the fiber optic cable, comprising:
a body portion configured to receive a fiber optic cable;
a cutting portion holding portion structurally configured to be supported by the body portion;
a sliding portion structurally configured to be slidingly received by a portion of the body portion;
wherein the cutting portion holding portion is structurally configured to receive an urging portion and to fixedly hold the cutting portion;
wherein the body portion comprises a bottom portion and a top portion structurally configured to receive a cable holding portion therebetween;
wherein the cable holding portion is structurally configured to pivot relative to the top portion and the bottom portion between an open position and a closed position;
wherein the bottom portion includes a cable guide portion structurally configured to receive a fiber optic cable;
wherein the cable guide portion includes an opening portion configured to receive the cutting portion;
wherein the cable holding portion and the cable guide portion are structurally configured to hold the fiber optic cable in the closed portion;
wherein the cable guide portion includes a stop portion that is structurally configured to set a length of a jacket of a fiber optic cable to be cut by the cutting portion; and
wherein the sliding portion is structurally configured to slide relative to the bottom portion so as overcome a force of the biasing portion and urge the cutting portion through the opening portion into the cable guide portion such that the cutting portion is configured to consistently cut a jacket of a fiber optic cable held by the cable holding portion and the cable guide portion along the set length as the bottom portion is slid relative to the fiber optic cable without cutting a fiber in the fiber optic cable.

2. The tool of claim 1, wherein the biasing portion is structurally configured to bias the cutting portion away from the cable guide portion.

3. The tool of claim 2, wherein the biasing portion includes a pair of springs, and wherein the cutting portion is disposed between the pair of springs.

4. The tool of claim 1, wherein the cutting portion includes a linear edge portion arranged at an acute angle with respect to a longitudinal axis of the cable guide portion.

5. A fiber optic cable cutting tool structurally configured to cut a fiber optic cable at a set length without cutting a fiber in the fiber optic cable, comprising:
a body portion configured to receive a fiber optic cable;
a cutting portion holding portion structurally configured to be supported by the body portion;
a sliding portion structurally configured to be slidingly received by a portion of the body portion;
wherein the cutting portion holding portion is structurally configured to receive a biasing portion and to fixedly hold the cutting portion;
wherein the body portion includes a cable guide portion structurally configured to receive a fiber optic cable;
wherein the cable holding portion and the cable guide portion are structurally configured to hold the fiber optic cable;
wherein the cable guide portion is structurally configured to set a length of a jacket of a fiber optic cable to be cut by the cutting portion; and
wherein the sliding portion is structurally configured to slide relative to the body portion so as overcome a force of the biasing portion and urge the cutting portion into the cable guide portion such that the cutting portion is configured to consistently cut a jacket of a fiber optic cable held by the cable holding portion and the cable guide portion along the set length as the body portion is slid relative to the fiber optic cable without cutting a fiber in the fiber optic cable.

6. The tool of claim 5, wherein the body portion comprises a bottom portion and a top portion structurally configured to receive the cable holding portion therebetween; and
wherein the cable holding portion is structurally configured to pivot relative to the top portion and the bottom portion between an open position and a closed position.

7. The tool of claim 6, wherein the bottom portion includes the cable guide portion.

8. The tool of claim 5, wherein the cable guide portion includes an opening portion configured to receive the cutting portion; and
wherein the sliding portion is structurally configured to slide relative to the bottom portion so as overcome a force of the biasing portion and urge the cutting portion through the opening portion in the cable guide portion.

9. The tool of claim 5, wherein the guide portion includes a stop portion that is structurally configured to set a length of a jacket of a fiber optic cable to be cut by the cutting portion.

10. The tool of claim 5, wherein the biasing portion is structurally configured to bias the cutting portion away from the cable guide portion.

11. The tool of claim 10, wherein the biasing portion includes a pair of springs, and wherein the cutting portion is disposed between the pair of springs.

12. The tool of claim 5, wherein the cutting portion includes a linear edge portion arranged at an acute angle with respect to a longitudinal axis of the cable guide portion.

13. A cable cutting tool structurally configured to cut a jacket of a cable at a set length without cutting elements contained by the jacket of the cable, comprising:
a body portion structurally configured to receive a cable;
a cutting portion holding portion structurally configured to be supported by the body portion;
a sliding portion structurally configured to be slidingly received by a portion of the body portion;
wherein the cutting portion holding portion is structurally configured to receive a biasing portion and to fixedly hold the cutting portion;
wherein the body portion is structurally configured to set a length of a jacket of a cable to be cut by the cutting portion; and
wherein the sliding portion is structurally configured to slide relative to the body portion so as overcome a force of the biasing portion and urge the cutting portion toward a cable held by the body portion such that the cutting portion is configured to consistently cut a jacket of the cable held by body portion along the set length as the body portion is slid relative to the cable without cutting elements contained by the jacket of the cable.

14. The tool of claim 13, wherein the body portion comprises a bottom portion and a top portion structurally configured to receive the cable holding portion therebetween; and
wherein the cable holding portion is structurally configured to pivot relative to the top portion and the bottom portion between an open position and a closed position.

15. The tool of claim 13, wherein the body portion includes a cable guide portion structurally configured to receive a cable.

16. The tool of claim 15, wherein the cable guide portion includes a stop portion that is structurally configured to set a length of a jacket of a cable to be cut by the cutting portion.

17. The tool of claim 15, wherein the biasing portion is structurally configured to bias the cutting portion away from the cable guide portion.

18. The tool of claim 15, wherein the biasing portion includes a pair of springs, and wherein the cutting portion is disposed between the pair of springs.

19. The tool of claim 15, wherein the cutting portion includes a linear edge portion arranged at an acute angle with respect to a longitudinal axis of the cable guide portion.

20. The tool of claim 15, wherein the cable guide portion includes an opening portion configured to receive the cutting portion; and
wherein the sliding portion is structurally configured to slide relative to the body portion so as overcome a force of the biasing portion and urge the cutting portion through an opening portion in the cable guide portion.
